(19) United States
(12) Patent Application Publication
(10) Pub. No.: US 2008/0222524 A1
(43) Pub. Date: Sep. 11, 2008

(54) Acoustic Signal Processing System

(75) Inventor: Kotaro TERADA, Hamamatsu-Shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 12/044,115

(22) Filed: Mar. 7, 2008

(30) Foreign Application Priority Data
Mar. 7, 2007 (JP) 2007-56702

(51) Int. Cl. G06F 3/048

(52) U.S. Cl. 715/716

(57) ABSTRACT

When controllers #1, #2 manipulate a parameter of a DSP #2, the controllers #1, #2 display an operator and a comment relating the parameter on a control screen. Text data indicative of the comment is stored in the DSP #2. When the controllers #1, #2 render the control screen, the controllers #1, #2 read out, from the DSP #2, the text data indicative of the comment which is to be added to the operator, and then display the comment on a display portion. As a result, the respective controllers #1, #2 are allowed to read out the text data stored in the DSP #2 to display the same comment on an operating screen, respectively, being able to share comments among the controllers #1, #2.

### BACKGROUND OF THE INVENTION

1. Field of the Invention

The present invention relates to an acoustic signal processing system provided with a signal processor which processes input acoustic signals to output the processed signals and a plurality of control apparatuses which communicate with the signal processor to control the signal processing. The present invention also relates to a control apparatus included in the plurality of control apparatuses applied to the acoustic signal processing system.

2. Description of the Related Art

As described in Japanese Patent Laid-Open No. 2002-304173 and Japanese Patent Laid-Open No. 2005-252543, acoustic signal processing systems in which a signal processor which processes input acoustic signals to output the processed signals and control apparatuses which operate the signal processor are connected with a transmission line have been disclosed. As a concrete acoustic signal processing system, mixing systems have been well-known. In the mixing systems, an engine portion which performs mixing processing and a console portion which conducts mixing operations of the mixing processing done by the engine portion are connected by a communications line. This configuration allows the engine portion to be placed in the neighborhood of a stage, also allowing the console portion to be placed in audience seats to allow a user to conduct mixing processing while checking the sound listened by audience.

As described above, the conventional acoustic signal processing systems are configured such that the control apparatuses manipulate parameters of the signal processor. In this configuration, in a case where a multiplicity of parameters are manipulated as in the case of the above-described mixing systems, an operating screen displays a multiplicity of operators in order to allow a user to manipulate the operators, resulting in difficulty for the user in finding a specific operator that the user desires to manipulate. However, there are only a limited number of parameters which users frequently manipulate or consider important. Therefore, users create a user control screen which displays only the parameters which the users frequently manipulate or consider important in order to facilitate manipulation of the parameters.

### DISCLOSURE OF THE INVENTION

### Problem to Be Solved by the Invention

Because the above-described user control screen is independently created by each user, the user control screen is supposed to have comments such as parameter names added to operators in order to improve operability of the displayed operators. In the above-described acoustic signal processing system, a plurality of control apparatuses can be connected to the transmission line with which the signal processor is connected so that the respective control apparatuses are allowed to operate the signal processor via the transmission line. In this case, the control apparatuses display a user control screen, respectively. More specifically, each of the control apparatuses displays its own comment added to a certain operator when a certain parameter of the signal processor is manipulated. Since the comment has been separately created by the respective control apparatuses, however, the control apparatuses display a different comment, respectively.

Detailed explanations will be given with reference to FIG. 13 of an example configuration of an acoustic signal processing system and FIGS. 14A, 148 of example user control screens. An acoustic signal processing system 100 shown in FIG. 13 is configured by a network which connects a first control apparatus (controller #1) 102, a second control apparatus (controller #2) 103, a first signal processor (DSP #1) 104, a second signal processor (DSP #2) 105, and an AD/DA converter 106 to a transmission line 107. Each of the two control apparatuses 102, 103 is designed to operate the two signal processors 104, 105. In FIG. 13, arrows indicate that the first control apparatus 102 and the second control apparatus 103 manipulate the same parameter of the second signal processor 105. The first control apparatus 102 and the second control apparatus 103 open a user control screen, respectively, in order to allow respective users to manipulate a parameter of the second signal processor 105. FIG. 14A shows a user control screen (control screen #1) displayed on a display unit of the first control apparatus 102, while FIG. 14B shows a user control screen (control screen #2) displayed on a display unit of the second control apparatus 103.

On the control screen #1 which is a screen for manipulating “Vocal Control”, a knob 130 for manipulating a parameter 1 and a button 131 for manipulating a parameter 2 are displayed. On the control screen #2 which is a screen for manipulating “Level Control”, a knob 140 for manipulating a parameter 3 and a button 141 for manipulating the parameter 2 are displayed. As described above, the buttons 131, 141 of the control screens #1, #2 are provided in order to manipulate the same parameter 2. On the control screen #1, the knob 130 is provided with a comment indicating that the parameter 1 is “Mic Level”, while the button 131 is provided with a comment indicating that the parameter 2 is “Main Vocal”. On the control screen #2, the knob 140 is not provided with any comment, while the button 141 is provided with a comment indicating that the parameter 2 is “Mic 1”. These comments have been separately created and stored by the control apparatuses 102, 103. As described above, the conventional system has a problem of inconsistency in comments added to operators which are provided in order to manipulate the same parameter.

### Object of the Invention

Therefore, an object of the present invention is to provide control apparatuses which are allowed to share a comment added to operators provided in order to manipulate the same parameter among the control apparatuses, the comment being displayed on an operating screen of the respective control apparatuses.

### Means for Solving the Problem

In order to achieve the above-described object, the primary characteristic of the control apparatus of the present invention is transmitting text data indicative of comments to a signal processor to store the text data in the signal processor, so that when display unit displays an operating screen the control apparatus reads out text data of a comment which is to be added to an operator from the signal processor and then displays the comment.

### Technical Effect of the Invention

According to the present invention, the respective control apparatuses read out text data stored in the signal processor, so that the control apparatuses display the same comment on the operating screen. As a result, the control apparatuses are allowed to share comments among the control apparatuses.

### BRIEF DESCRIPTION OF THE DRAWINGS

FIG. 1 is a block diagram showing a general configuration of an acoustic signal processing system having control apparatuses of an embodiment of the present invention;

FIG. 2 is a block diagram showing a detailed configuration of the control apparatus of the embodiment of the present invention;

FIG. 3 is a diagram showing a configuration in which the two control apparatuses manipulate a signal processor in the acoustic signal processing system having the control apparatuses of the embodiment of the present invention;

FIG. 4 is an example property of a parameter of the signal processor manipulated by the control apparatuses of the embodiment of the present invention;

FIG. 5A, FIG. 5B are diagrams showing example control screens having comments displayed on the control apparatuses of the embodiment of the present invention;

FIG. 6 is a flowchart of a comment addition program to be executed on the control apparatus of the embodiment of the present invention;

FIG. 7 is a flowchart of a parameter addition program to be executed on the control apparatus of the embodiment of the present invention;

FIG. 8 is a flowchart of a parameter manipulation program to be executed on the control apparatus of the embodiment of the present invention;

FIG. 9 is a diagram showing an example property of a comment which has a conditional format, the comment being added to a parameter of the signal processor manipulated by the control apparatus of the embodiment of the present invention;

FIGS. 10A, 10B are example control screens having a conditional comment displayed on the control apparatus of the embodiment of the present invention;

FIG. 11 is an example window for setting comments having a conditional format on the control apparatus of the embodiment of the present invention;

FIG. 12 is a flowchart of a comment display program to be executed on the control apparatus of the embodiment of the present invention;

FIG. 13 is a diagram showing an example configuration of a conventional acoustic signal processing system; and

FIGS. 14A, 14B are diagrams showing example user control screens used in the conventional acoustic signal processing system.

### DESCRIPTION OF THE PREFERRED EMBODIMENT

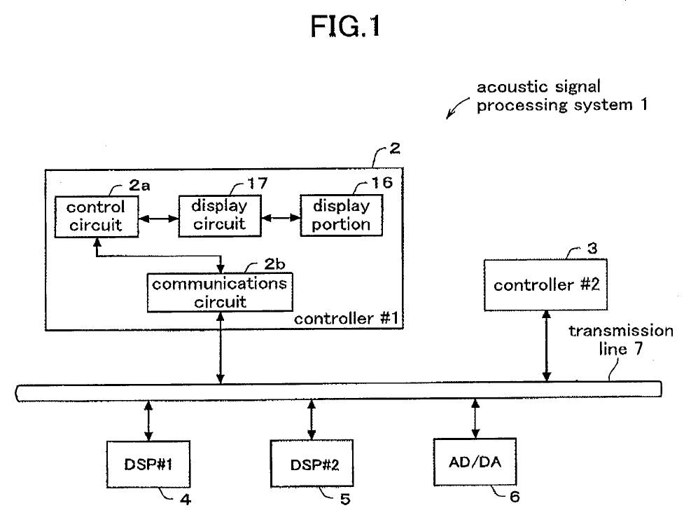

FIG. 1 shows a block diagram showing a general configuration of an acoustic signal processing system having control apparatuses of an embodiment of the present invention. An acoustic signal processing system 1 shown in FIG. 1 is configured by a network which connects a first control apparatus (controller #1) 2, a second control apparatus (controller #2) 3, a first signal processor (DSP #1) 4, a second signal processor (DSP #2) 5, and an AD/DA converter 6 to a transmission line 7, respectively. More specifically, the acoustic signal processing system 1 is provided with the two signal processors 4, 5 and the two control apparatuses 2, 3. Each of the two control apparatuses 2, 3 is allowed to operate the two signal processors 4, 5. The first control apparatus 2 and the second control apparatus 3 are configured similarly. In FIG. 1, a general configuration of only the first control apparatus 2 is shown as an example.

Configuration of the first control apparatus 2 and the second control apparatus 3 will be described with reference to the configuration of the first control apparatus 2. The first control apparatus 2 is configured by a communications circuit 2b, a control circuit 2a, a display portion 16 and a display circuit 17. The communications circuit 2b includes a communications interface which transmits and receives control signals and acoustic signals as packet data to/from the transmission line 7. The control circuit 2a includes a CPU which controls the entire first control apparatus 2. The display portion 16 has a liquid crystal display unit and the like. The display circuit 17 displays an operating screen on the display portion 16 when the first control apparatus 2 operates the first signal processor 4 and the second signal processor 5.

The first signal processor 4 and the second signal processor 5 are equipped with a DSP (Digital Signal Processor). The first signal processor 4 and the second signal processor 5 also have a register for storing values of parameters provided by the first control apparatus 2 and the second control apparatus 3, and a storage potion for storing text data indicative of later-described comments. The AD/DA converter 6 converts input analog acoustic signals into digital acoustic signals to transmit the converted acoustic signals to the transmission line 7, while the AD/DA converter 6 also converts digital acoustic signals received from the transmission line 7 into analog acoustic signals to output the converted analog acoustic signals.

In a case where the acoustic signal processing system 1 is operated as a mixing system, for example, the first signal processor 4 and the second signal processor 5 which are signal processing portions serve as an engine portion, so that their integrated DSPs process acoustic signals provided for a plurality of channels. For input signal lines, more specifically, the first signal processor 4 and the second signal processor 5 have a plurality of input channels such as digital acoustic signals and microphone input transmitted from the AD/DA converter 6 to program the input signal lines to mix input signals. The first signal processor 4 and the second signal processor 5 then conduct signal processing for outputting the mixed signals to a plurality of output channels provided as output signal lines. The first control apparatus 2 and the second control apparatus 3 which are control portions serve as a console portion, so that the first control apparatus 2 and the second control apparatus 3 transmit control signals to the transmission line 7 to manipulate the mixing processing by the first signal processor 4 and the second signal processor 5.

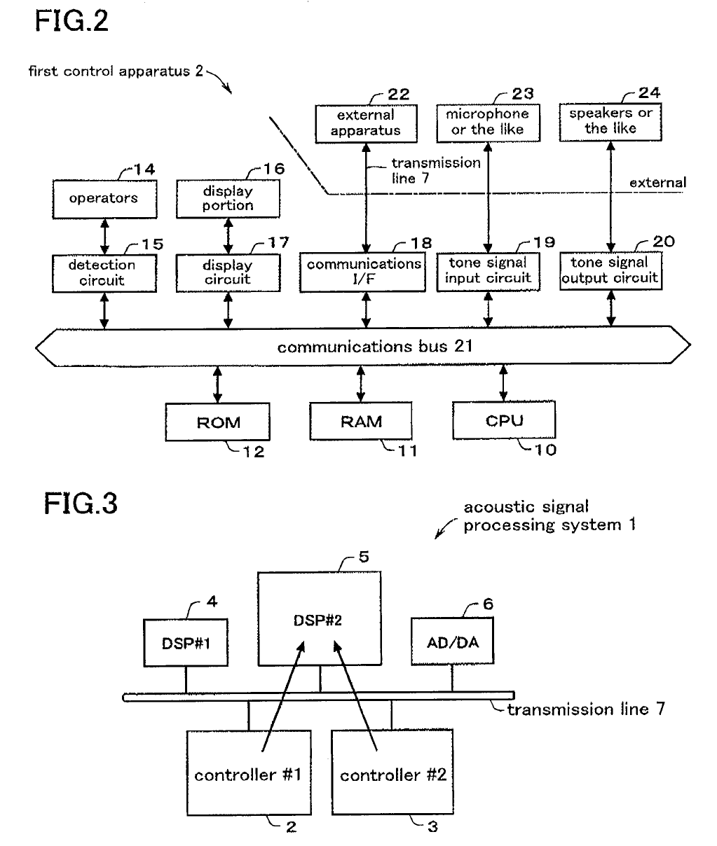

Next, FIG. 2 shows a block diagram showing a detailed configuration of the first control apparatus 2 having a configuration similar to that of the second control apparatus 3. In FIG. 2, a CPU (Central Processing Unit) 10 controls the entire operation of the first control apparatus 2. In addition, the CPU 10 also executes operational software such as a rendering program for displaying an operating screen or the like on the display portion 16 and a program for operating the signal processing portions of the first signal processor 4 and the second signal processor 5. A RAM (Random Access Memory) 11 is provided with a working area for the CPU 10 and a storage area for storing various kinds of data. A ROM (Read Only Memory) 12 stores at least operational software such as the rendering program and a control program to be executed by the CPU 10. As the ROM 12, a rewritable ROM such as flash memory may be employed to allow rewrite of operational software to facilitate upgrade of the operational software.

A detection circuit 15 scans operators 14 such as panel operators to detect an event of the operator 14. The detection circuit 15 then outputs an event signal corresponding to the event of the operator 14. The operators 14 include a multiplicity of operators for controlling equalizing characteristics of the respective channels, characteristics of level to transmit to a mixing bus, panning characteristics and the like and for switching scenes. The multiplicity of operators include various kinds of operators such as on/off operators, slide operators and a mouse (pointing device). The display circuit 17 displays, on a display portion 16 such as a liquid crystal display (LCD), an operating screen (control screen) on which a user makes various settings when the user specifies parameters of the respective channels of the first signal processor 4 and the second signal processor 5. The various settings are made by the user's manipulation made on the operating screen which uses GUI (Graphical User Interface). A communications interface (I/F) 18 is an interface for connecting the first control apparatus 2 with the transmission line 7 which is a communications network such as a LAN (Local Area Network), the Internet or a telephone line. By connecting the communications interface (I/F) 18 with the communications network, the first control apparatus 2 is logically connected with an external apparatus 22 which is the first signal processor 4 and the second signal processor 5.

By configuring the first control apparatus 2 and the second control apparatus 3 as such, the first control apparatus 2 or the second control apparatus 3 is allowed to transmit packets of control signals and acoustic signals to the external apparatus 22 through the transmission line 7. The first control apparatus 2 or the second control apparatus 3 is allowed to receive packets of acoustic signals output from the external apparatus 22 through the transmission line 7. A tone signal input circuit 19 retrieves acoustic signals from an input portion 23 such as a microphone for retrieving external tones into the first control apparatus 2 or the second control apparatus 3. A tone signal output circuit 20 outputs acoustic signals for which processing such as mixing has been conducted to an output portion 24 such as external speakers to emit tones, the acoustic signals being output from the first control apparatus 2 or the second control apparatus 3. These respective components are connected to a communications bus 21 to transmit/receive data through the communications bus 21.

The first signal processor 4 and the second signal processor 5, which are equipped with the DSP, are not provided with any operators and display portion in order to have a simple configuration. More specifically, the first signal processor 4 and the second signal processor 5 are obtained by adding the DSP to the configuration of the first control apparatus 2 shown in FIG. 2 and removing the operators 14, the detection circuit 15, the display portion 16 and the display circuit 17. If the first signal processor 4 or the second signal processor 5 is connected to the transmission line 7, the first signal processor 4 or the second signal processor 5 is logically connected to the first control apparatus 2 and the second control apparatus 3 which are the external apparatus or another signal processor through an integrated communications interface and the transmission line 7.

As described above, each of the two control apparatuses 2, 3 is allowed to operate the two signal processors 4, 5. In FIG. 3, arrows indicate a configuration in which the first control apparatus 2 and the second control apparatus 3 manipulate the same parameter of the second signal processor 5 in the acoustic signal processing system 1. At the time of the manipulation, the first control apparatus 2 and the second control apparatus 3 display a user control screen in order to allow respective users to manipulate the parameter of the second signal processor 5, respectively. Example user control screens are shown in FIG. 5A and FIG. 5B. The control screen shown in FIG. SA is a user control screen (control screen #1) displayed on the display portion 16 of the first control apparatus 2. The control screen shown in FIG. 5B is a user control screen (control screen #2) displayed on a display unit of the second control apparatus 3.

The control screen #1 is a screen for manipulating “Vocal Control” parameter. On the screen, a knob 30 for manipulating a parameter 1, for example, and a button 31 for manipulating a parameter 2, for example, are displayed. The control screen #2 is a screen for manipulating “Level Control” parameter. On the screen, a knob 40 for manipulating a parameter 3, for example, and a button 41 for manipulating the parameter 2 are displayed. As described above, the buttons 31, 41 of the control screens #1, #2 are provided for manipulating the same parameter 2. On the control screen #1, the knob 30 is displayed with a comment indicating the parameter 1 is considered as “Vox1 Level”, while the button 31 is displayed with a comment indicating the parameter 2 is considered as “Main Vocal”. On the control screen #2, the knob 40 is displayed without any comment on the parameter 3, while the button 41 is displayed with the comment indicating the parameter 2 is considered as “Main Vocal”. On the control apparatuses according to the present invention, therefore, the buttons 31, 41 which are operators for manipulating the same parameter 2 share the same comment. In addition, respective parameters displayed on control screens can be provided with respective comments. However, the comments can be hidden.

A comment provided for an operator displayed on a user control screen is created by the control apparatus 2 or the control apparatus 3, while text data indicative of the created comment is transmitted to the first signal processor 4 or the second signal processor 5 which has a parameter to be manipulated by the operator for which the comment is provided. The text data received by the first signal processor 4 or the second signal processor 5 is then stored in the first signal processor 4 or the second signal processor 5. When the parameter 2 is manipulated on the first control apparatus 2, for example, the control screen #1 is displayed on the display portion 16. More specifically, the first control apparatus 2 accesses the second signal processor 5 which has the parameter 2 to read out text data indicative of a comment stored in property of the parameter 2 to display the read text data on the display portion 16. When the same parameter 2 is manipulated on the second control apparatus 3 as well, the control screen #2 is displayed on the display portion 16 of the second control apparatus 3. More specifically, the second control apparatus 3 accesses the second signal processor 5 which has the parameter 2 to read out the text data indicative of the comment stored in the property of the parameter 2 to display the read text data on the display portion 16. Because text data indicative of a comment to be provided for a parameter is stored by the signal processor which has the parameter as the property of the parameter, as described above, the plurality of control apparatuses are allowed to share the comment.

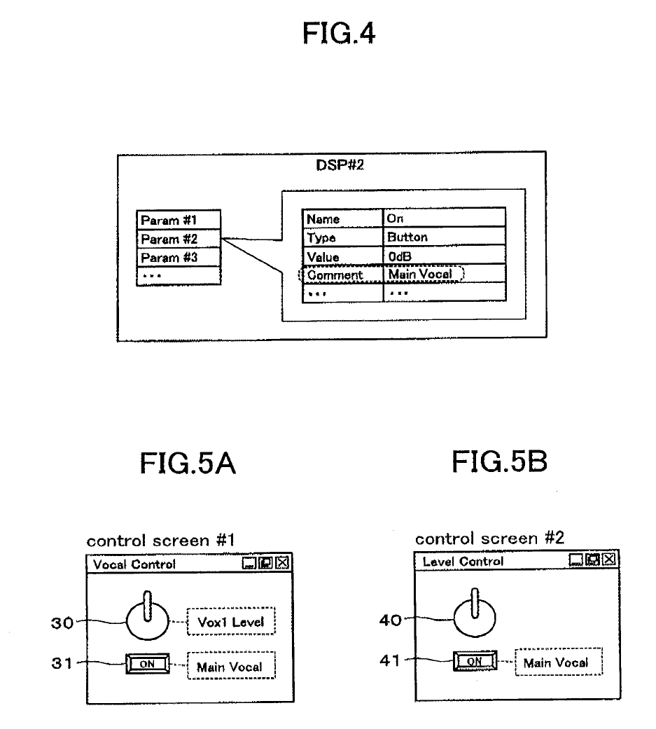

An example property of a parameter which the second signal processor 5 has is shown in FIG. 4. The second signal processor (DSP #2) 5 has a parameter 1 (Param #1), a parameter 2 (Param #2), a parameter 3 (Param #3) and the like. FIG. 4 shows a screen to be displayed on the display portion 16 when the property of the parameter 2 (Param #2) is opened. As shown in FIG. 4, the property of the parameter 2 (Param #2) defines the name of the parameter (Name) as “On”, the type of an operator (Type) as “Button”, the value of the parameter (Value) as “0 dB”, and a comment (Comment) as “Main Vocal”. More specifically, “On” indicates that the type of the parameter is something to be turned on, while “Button” indicates that the operator is a button. Respective properties of other parameters are also configured similarly. When the first control apparatus 2 manipulates the parameter 2, the first control apparatus 2 accesses the second signal processor (DSP #2) 5 to read out the text data of the comment indicative of “Main Vocal” from the property of the parameter 2 (Param #2) to display the text data on the display portion 16. As shown in FIG. 5A, as a result, the button 31 of the control screen #1 is provided with the comment of “Main Vocal”. In a case where the second control apparatus 3 similarly manipulates the parameter, the second control apparatus 3 accesses the second signal processor (DSP #2) 5 to read out the text data of the comment indicative of “Main Vocal” from the property of the parameter 2 (Param #2) to display the comment on the display portion 16. As shown in FIG. 5B, as a result, the button 41 of the control screen #2 is provided with the comment of “Main Vocal”.

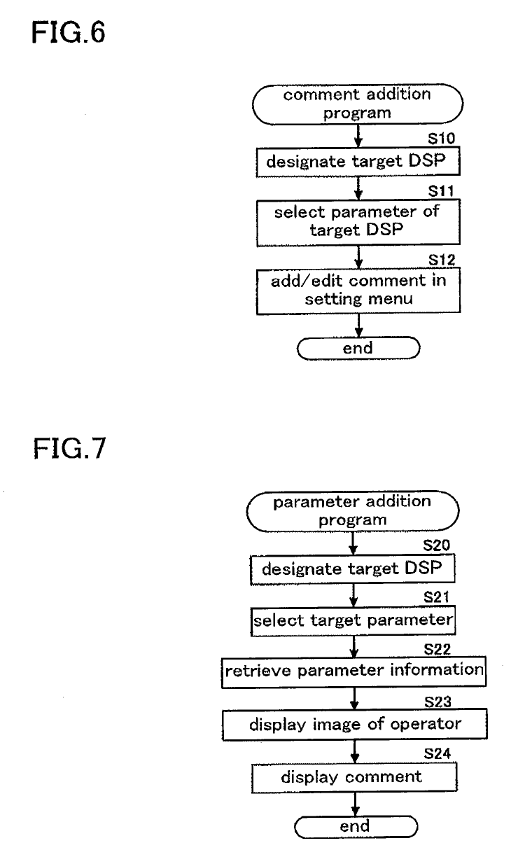

FIG. 6 is a flowchart of a comment addition program to be executed on the control apparatus when a comment is added to a parameter. The comment addition program is started by a user's manipulation for adding a comment. In step S10, a user designates, as a target DSP, a signal processor which has a parameter to which the user desires to add a comment. In step S11, the user selects a parameter of the target DSP to which the user desires to add a comment from among a menu of a tool bar or context menu. In step S12, the user adds or edits a comment in a setting menu displayed on the display portion 16. On completion of the addition or editing of the comment, text data indicative of the added or edited comment is transmitted to the target DSP. The comment addition program is then terminated. The signal processor designated as the target DSP adds the comment to the property of the user's selected parameter or rewrites the comment stored in the property of the user's selected parameter.

FIG. 7 is a flowchart of a parameter addition program to be executed on the control apparatus when a parameter is added to a user control screen. The parameter addition program is started by a user's manipulation for adding a parameter to a user control screen. In step S20, the user designates, as a target DSP, a signal processor which has a parameter which the user desires to add. In step S21, the user selects a parameter of the target DSP which the user desires to add from among a menu of a tool bar or context menu. In step S22, the control apparatus retrieves identification information of the target DSP and parameter number of the selected parameter as parameter information. In step S23, the control apparatus accesses the signal processor on the basis of the retrieved parameter information, retrieves the type of an operator of the selected parameter and text data of a comment to be added to the parameter, adds an image of the operator corresponding to the retrieved type of the operator to the user control screen, and then displays the refreshed user control screen. On the basis of the retrieved text data, in step S24, the control apparatus adds the comment to the user control screen and then displays the refreshed user control screen. The parameter addition program is then terminated.

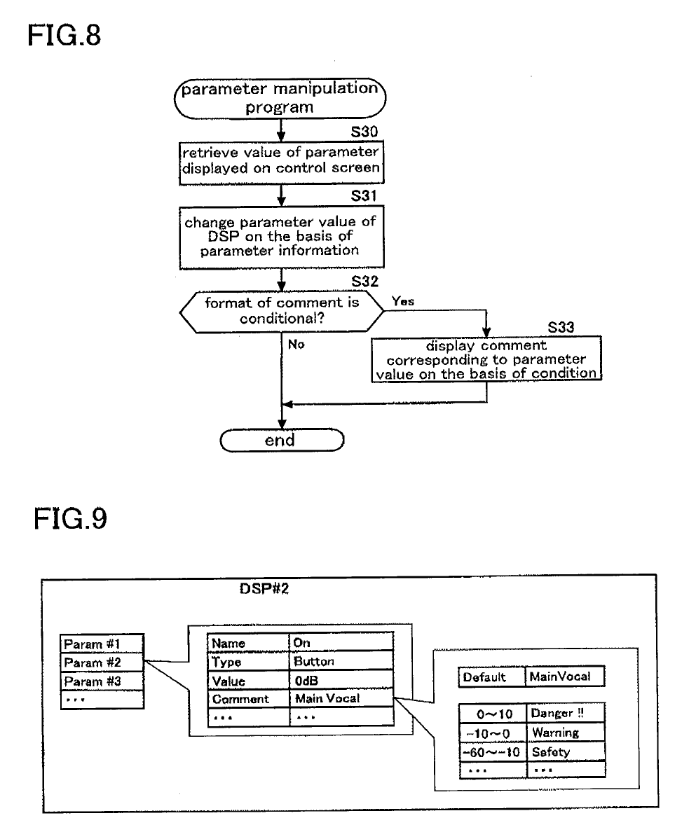

FIG. 8 is a flowchart of a parameter manipulation program to be executed on the control apparatus when the user manipulates a parameter on a user control screen. The parameter manipulation program is started by a user's manipulation of an operator displayed on the user control screen. In step S30, the control apparatus retrieves a value of a parameter of the operator which the user has manipulated.

At the time of the retrieval of the parameter value, the user points and clicks a movable part (knob, button or the like) of the operator displayed on the user control screen by using a mouse (pointing device), and then drags the mouse. Alternatively, the displayed operator may be manipulated by use of a manual operator other than the mouse. The user's manipulation is detected by the detection circuit 15, while the control apparatus retrieves the amount of the manipulation of the displayed operator from the detection circuit 15. Instead of the user's manipulation, the display portion 16 may be configured by a touch panel so that the user can manipulate the movable part of the operator displayed on the user control screen with the touch of the screen. In this case as well, the control apparatus collaborates with the touch panel to detect the user's touch manipulation. At the time of the user's manipulation of the displayed operator, the control apparatus linearly moves or turns the movable part (knob, button or the like) of the displayed operator displayed on the user control screen in synchronization with the retrieval of the amount of the manipulation.

In step S31, on the basis of the parameter information of the manipulated parameter, the control apparatus transmits the retrieved parameter value to the signal processor having the manipulated parameter, while the signal processor changes a value of the parameter to the parameter value obtained after the user's manipulation. In step S32, the control apparatus determines whether the comment provided for the manipulated parameter has a format having conditions. In a case where it is determined that the comment has a conditional format, the control apparatus retrieves a comment corresponding to the obtained parameter value from the signal processor, and displays the comment on the user control screen in step S33. The parameter manipulation program is then terminated. In a case where it is determined that the comment does not have a conditional format, the parameter manipulation program is terminated without the process of step S33.

An example comment which has a conditional format is shown in FIG. 9. FIG. 9 shows an example property of a comment (Comment) included in the property of the parameter 2 (Param #2) of the second signal processor 5. As shown in FIG. 9, a default value (Default) of the comment (Comment) is “Main Vocal”. In a case where the parameter value of “Main Vocal” is fallen within the range of “0 to 10” dB, the comment is “Danger!!”, for tones will be split or distorted due to its excessively high level. In a case where the parameter value of “Main Vocal” is fallen within the range of “−10 to 0” dB, the comment is “Warning”, for there is risk of split or distortion of tones due to its high level. In a case where the parameter value of “Main Vocal” is fallen within the range of “−60 to −10” dB, the comment is “Safety”, for the level is fallen within an appropriate range.

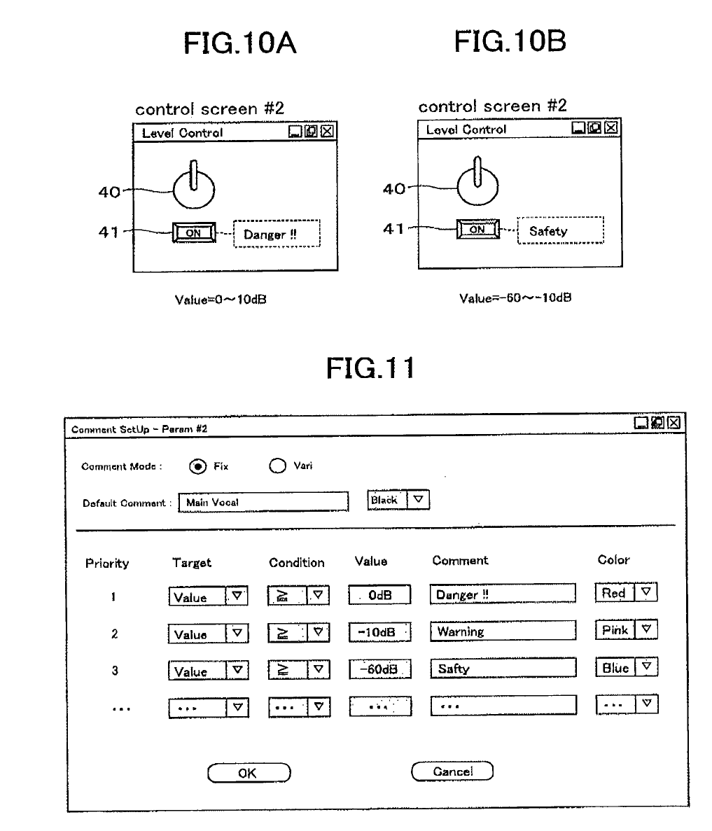

FIG. 10A and FIG. 10B show examples displayed on the control screen #2 in a case where the parameter manipulation program is carried out for the manipulation of the parameter 2 (Param #2) of the second signal processor 5. FIG. 10A shows the control screen #2 of a case where the user has manipulated the operator, so that the parameter value of “Main Vocal” which is the parameter 2 (Param #2) has fallen within the range of “0 to 10” dB. In this case, the comment provided for the button 41 is “Danger!!”. This comment, “Danger!!” is obtained by the control apparatus by accessing the second signal processor 5 to read out in association with the parameter value of the range of “0 to 10” from the property of the comment (Comment) of the parameter 2 (Param #2). FIG. 10B shows the control screen #2 of a case where the user has manipulated the operator, so that the parameter value of “Main Vocal” which is the parameter 2 (Param #2) has fallen within the range of “−60 to −10” dB. In this case, the comment provided for the button 41 is “Safety”. This comment, “Safety” is obtained by the control apparatus by accessing the second signal processor 5 to read out in association with the parameter value of the range of “−60 to −10” from the property of the comment (Comment) of the parameter 2 (Param #2).

FIG. 11 shows an example window for setting comments having a conditional format on the control apparatus. FIG, 11 is a screen for setting up comments of the parameter 2 (Param #2) of the signal processor 5. On the set-up screen shown in FIG. 11, the user is allowed to select either “Fix” or “Vari” as comment mode (Comment Mode). If “Fix” is selected, the comment is fixed in spite of the conditional format, so that the comment will not change according to parameter value. If “Vari” is selected, the comment varies according to parameter value. On the shown screen, “Fix” is selected. A default comment of the parameter is “Main Vocal”. As the color for displaying the comment, black is selected. At the time of setting up of comments, the user is allowed to specify Priority, Target, Condition, Value, Comment, and Color, respectively. In the shown example, a case where if the parameter value of “Main Vocal” is 0 dB or more, a comment of “Danger!!” is displayed in red is placed at the highest priority. A case where if the parameter value of “Main Vocal” is −10 dB or more, a comment of “Warning” is displayed in pink is placed at the second highest priority. A case where if the parameter value of “Main Vocal” is −60 dB or more, a comment of “Safety” is displayed in blue is placed at the third highest priority. In order to confirm the user's specified contents, the user clicks “OK” provided in the lower part of the screen. In order to delete the user's specified contents, the user clicks “Cancel” provided in the lower part of the screen.

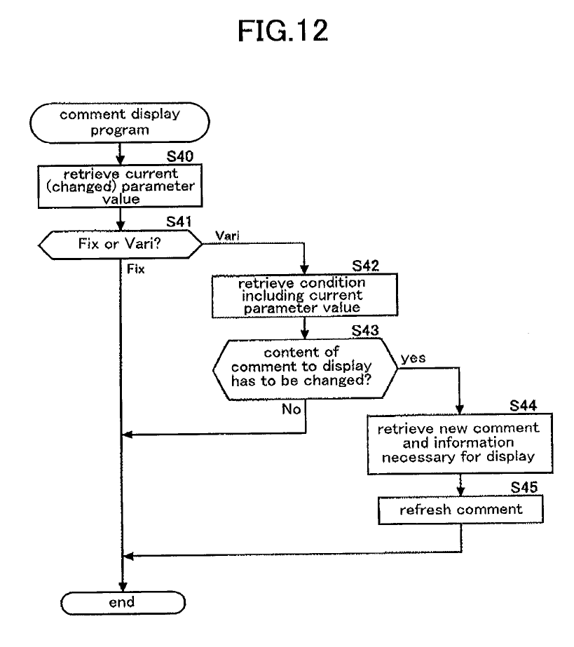

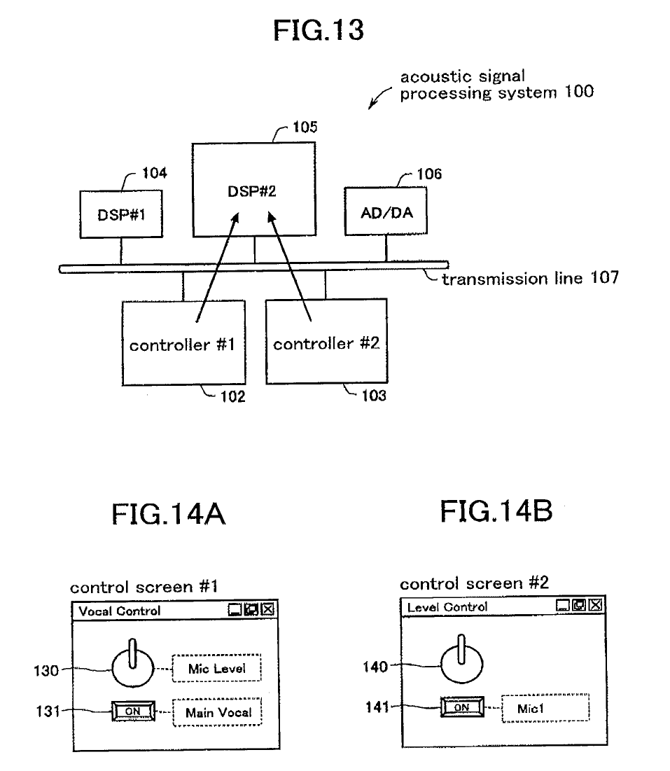

FIG. 12 is a flowchart of a comment display program to be executed on the control apparatus which displays a comment which has been set up on the set-up screen shown in FIG. 11. The comment display program is started when the user has performed manipulation for displaying the user control screen or when the user has manipulated a parameter on the user control screen. In step S40, the control apparatus retrieves the current value or a changed value of a parameter related to an operator displayed on the user control screen. In step S41, the control apparatus determines on the basis of the parameter information of the parameter whose value has been retrieved whether the comment mode of the parameter is set in either “Fix” or “Vari”. If the comment mode is “Fix”, the comment display program is terminated, for there is no need to change the content of the comment. If the comment mode is “Vari”, the control apparatus accesses, in step S42, a signal processor having the parameter to retrieve a condition which includes the current parameter value from the property of the parameter.

After the retrieval of the condition, the control apparatus determines in step S43 whether the content of the comment to display has to be changed. If it is determined that the content of the comment to display is suitable for the current parameter value when the retrieved condition is referred to, the comment display program is terminated, for there is no need to change the content of the comment to display. If it is determined that the content of the comment to display is not suitable for the current parameter value when the retrieved condition is referred to, the control apparatus accesses, in step S44, the signal processor having the parameter to retrieve a new comment suitable for the current parameter value and information necessary for rendering from the property of the parameter. In step S45, the control apparatus refreshes the comment on the basis of the retrieved new content and information necessary for rendering. As a result, the comment suitable for the current parameter value is displayed on the user control screen. The comment display program is then terminated.

As described above, the present invention does not make a GUI of the controller store comments to be provided for parameters displayed on control screens but makes the signal processors which are manipulated by the control apparatuses store the comments. Furthermore, the present invention not only allows the signal processors to store text data of the comments but also allows to change the content of the comments according to value (condition). More specifically, the present invention allows sharing of comments of parameters which are manipulated by the plurality of control apparatuses among the control apparatuses, enabling every control apparatus to similarly handle the comment data. Since the content of a comment is changed according to value (condition) and then displayed, in addition, the present invention facilitates emergency notification by use of comments. In this case, the content of the comment can be changed according to security level or users.

In carrying out the present invention, in addition to the above-described embodiment, various modifications can be made without departing from the spirit and scope of the invention,

What is claimed is:

1. An acoustic signal processing system having a signal processor which processes input acoustic signals to output the processed signals and a plurality of control apparatuses which communicate with the signal processor to control the signal processing;
the signal processor comprising:
a signal processing potion for processing input acoustic signals in accordance with a plurality of parameters; and
a storing portion for storing a plurality of parameters used for processing of acoustic signals by the signal processing portion and first comments for improving operability of the plurality of parameters in association with the plurality of parameters; and
each of the plurality of control apparatuses comprising:
a display unit;
a display controller for displaying, on the display unit, an operator for operating at least one parameter selected by a user from among the plurality of parameters stored in the storing portion of the signal processor and a first comment corresponding to the operator, the first comment being stored in the storing portion of the signal processor and received from the signal processor; and
a parameter changing portion for changing the selected at least one parameter by manipulation of the displayed operator and transmitting the changed parameter to the signal processor.

2. An acoustic signal processing system according to claim 1, wherein
the parameter changing portion manipulates the operator displayed on the display unit by use of a manual operator.

3. An acoustic signal processing system according to claim 1, wherein
the parameter changing portion manipulates the operator displayed on the display unit by touch operation on the display unit.

4. An acoustic signal processing system according to claim 1, wherein
each of the plurality of control apparatuses further comprises a comment creating portion for creating or editing the first comment, transmitting the first comment to the signal processor and then making the signal processor store the first comment in the storing portion.

5. An acoustic signal processing system according to claim 1, wherein
the storing portion of the signal processor also stores a plurality of second comments which vary in accordance with parameter value which is changed by the control apparatuses, unlike the first comments; and
the display controller of the plurality of control apparatuses selectively displays the first comments and the second comments on the display unit.

6. A control apparatus included in a plurality of control apparatuses applied to an acoustic signal processing system having a signal processor which processes input acoustic signals to output the processed signals and the plurality of control apparatuses which communicate with the signal processor to control the signal processing, the control apparatus comprising:
a display unit;
a display controller for displaying, on the display unit, an operator for operating at least one parameter selected by a user from among a plurality of parameters of the signal processor and a first comment corresponding to the parameter related to the operator, the first comment being stored in the signal processor and received from the signal processor; and
a parameter changing portion for changing the selected at least one parameter by manipulation of the displayed operator and transmitting the changed parameter to the signal processor.

7. A control apparatus according to claim 6, wherein
the parameter changing portion manipulates the operator displayed on the display unit by use of a manual operator.

8. A control apparatus according to claim 6, wherein
the parameter changing portion manipulates the operator displayed on the display unit by touch operation on the display unit.

9. A control apparatus according to claim 6 further comprising:
a comment creating portion for creating or editing the first comment, transmitting the first comment to the signal processor and then making the signal processor store the first comment.

10. A control apparatus according to claim 6, wherein
the display controller receives, from the signal processor, a plurality of second comments which are stored in the signal processor and vary in accordance with parameter value which is changed by the control apparatuses unlike the first comments, and selectively displays the first comments and the second comments on the display unit.
